(19) United States
(12) Patent Application Publication
(10) Pub. No.: US 2024/0135284 A1
(43) Pub. Date: Apr. 25, 2024

(54) ASSET RECONCILIATION BASED ON GEOLOCATION

(71) Applicant: Charles Mark Russell, Canton, GA (US)

(72) Inventor: Charles Mark Russell, Canton, GA (US)

(21) Appl. No.: 17/971,923

(22) Filed: Oct. 23, 2022

(51) Int. Cl. G06Q 10/06; G06Q 10/08; G06Q 30/02

(52) U.S. Cl. CPC G06Q 10/06315; G06Q 10/087; G06Q 30/0206

(57) ABSTRACT

Methods, systems, and apparatus, including computer programs encoded on a computer storage medium, for reconciling assets based on geolocation. In one aspect, a method includes selecting assets having geolocation parameter data satisfied by the first location, and using these selected assets as a basis for a task comparison summary.

### BACKGROUND

This specification relates to asset reconciliation based on geolocation, and in particular, based on the geolocation of an asset at a particular time.

Certain tasks, such as remediation tasks, require hardware assets in addition to workers. Some of these assets are high value assets that are expensive and in limited supply. For example, a tree remediation service may require a crane asset; a flood remediation service may require large dryers and high volume pumps, etc. Additionally, when the need for such remediation services occurs, the need is often in high demand. For example, a storm may cause flooding and down a number of trees over a larger service area of remediation providers. During these high demand periods, the cost of the remediation services may rise significantly due to a number of factors, such as overtime pay requirements for workers, the scarcity of high value assets driving up the cost of equipment rental, the increased travel time to job sites driving up the costs of fuel and equipment usage, etc.

Remediation tasks are often expensive and payment is often subject to insurance carriers. Insurance carriers are supposed to pay market rates, which are reasonable and customary rates for mitigation work performed on insurance claims. However, it can take a significant amount of time for adjusters to determine the market rates after the work is performed, especially during periods when remediation demands are high, which results in a high volume of claims and volatile market rates when compared to times when remediation demands are relatively low.

Moreover, during times of disaster, supply and demand changes constantly. Arrival times differ drastically as emergency mitigation assets are deployed to different areas for different tasks. For example, cranes may be deployed from one state to another state, e.g., from Georgia to Florida, to remove trees off of houses after a hurricane. While such deployment may help in keeping asset rates down in affected areas in Florida during a high demand period, the resulting scarcity of assets in Georgia may drive the asset rates up in areas of Georgia despite the relatively normal level of demand in Georgia. Additionally, asset providers rarely keep historical logs of where their high value assets are committed. Thus, it can be very difficult to determine an actual market rate for a service area for which property was largely unaffected by a natural disaster but for which assets were suddenly scarce.

### SUMMARY

In general, one innovative aspect of the subject matter described in this specification can be embodied in methods that include the actions of receiving, at the data processing apparatus, data indicating a task that is accepted at an acceptance time and to be performed at a first location by a first provider; determining, by the data processing apparatus and for the task, a set of assets that are allocated to perform the task, wherein at least one of the assets is of a first asset type allocated based on geolocation parameter data specified for the asset; determining, by the data processing apparatus and for the first asset type, a set of first assets of the first asset type, each of which has geolocation parameter data specified for the first asset, and each of which is associated with respective second providers; selecting, by the data processing apparatus and from the set of first assets, a proper subset of first assets, wherein: the geolocation parameter data for each of the first assets in the proper subset of first assets is satisfied by the first location, and the geolocation parameter data for each of the first assets not in the proper subset of first assets is not satisfied by the first location; for each respective second provider associated with a first asset in the proper subset of first assets, generating, by the data processing apparatus, a candidate task allocation for the task, the candidate task allocation comprising: the first asset associated with the respective second provider, one or more other assets, each of the one or more other assets being of an asset type that is different from the first asset type and associated with the respective second provider; generating, by the data processing apparatus, a task comparison that includes a task summary for the task that that is accepted and, for each respective second provider, a task summary for the task based on the candidate task allocation for each respective second provider; storing, by the data processing apparatus, the task comparison in a data store; and providing, by the data processing apparatus, the task comparison to a third party; wherein the data processing apparatus is separate from the first provider and each of the second providers. Other embodiments of this aspect include corresponding systems, apparatus, and computer programs, configured to perform the actions of the methods, encoded on computer storage devices.

In some implementations, the geolocation parameter data for each of the first assets specifies a service area; and selecting, from the set of first assets, the proper subset of first assets, comprises: for each first asset, determining whether the first location was within the service area specified by the geolocation parameter data for the first asset at the acceptance time; and determining the geolocation parameter data for the first asset is satisfied by the first location when the first location is within the service area specified by the geolocation parameter data for the first asset at the acceptance time.

In some implementations, the service area specified by the geolocation parameter data is specified by the provider associated with the first asset.

In some implementations, the method includes periodically receiving, by the data processing apparatus, for each first asset, data indicating a current service area for the first asset.

In some implementations, periodically receiving, by the data processing apparatus, for each first asset, data indicating the current geolocation of the first asset, comprises receiving, from a device affixed to the first asset, the data indicating the current location of the first asset.

In some implementations, the method includes determining the geolocation parameter data for the first asset is satisfied when the current geolocation of the first asset is within a threshold distance of the service area.

In some implementations, the service area specified by the geolocation parameter data is limited to a maximum service area that is measure from a home base of the first asset; and each first asset in the proper subset of first assets has geolocation parameter data specifying a maximum service area that includes the first location.

In some implementations, for each respective second provider associated with a first asset in the proper subset of first assets, generating a candidate task allocation comprises: determining, for the first asset, a location of the first asset at the acceptance time; determining, based in part of the location of the first asset, an arrival time at the first location determined from the acceptance time; and including, in the task allocation, data specifying the arrival time of the first asset.

In some implementations, for each respective second provider associated with a first asset in the proper subset of first assets, generating a candidate task allocation comprises: determining, for the first asset and each of the other assets, a respective task cost; and including, in the candidate task allocation, data specifying the respective task costs.

In some implementations, each respective task cost is a cost determined for the acceptance time.

In some implementations, generating the task summary for the task based on the candidate task allocation for each respective second provider comprises generating an anonymized task summary that does not reveal the identity of each second provider.

In some implementations, the geolocation parameter data for each first asset is time varying such that the geolocation parameter data differs based on time; and the geolocation parameter data for each of the first assets in the proper subset of first assets is satisfied by the first location at the acceptance time.

Particular embodiments of the subject matter described in this specification can be implemented so as to realize one or more of the following advantages. Because asset data availability for a geographic area is specified according to time, the use of an acceptance time of a task for a location can quickly result in a listing of all candidate asset allocations within that market at the acceptance time. This results in an accurate depiction of the market at the acceptance time, and thus the corresponding market rates can be determined with a high degree of accuracy. This, in turn, reduces the amount of time to determine the market at a given time. For example, the collection of data over time to reconstruct a particular market at an acceptance time in the past requires significant data analysis efforts, often entailing computer modeling and error minimization. The subject matter described below, however, enables the capture of an actual market that include actual providers for a given service area at an acceptance time, thus ensuring a much higher degree of accuracy of a given market with much less data processing.

Additionally, in implementations in which individual providers allow the task to be allocated by use of the asset reconciliation system, asset allocations and scarcity factors can be adjusted in real time, i.e., at the time the task is agreed to and accepted by a customer, which also facilitates a more accurate depiction of a market within a service area. The use of an application programming interface (or some other network enabled connection) to link service providers to the asset reconciliation system enables reception of task allocation data from multiple service providers in myriad formats to be converted into a standardized format to facilitate data storage and processing. This, in turn, reduces data collection errors and processing time required for the construction of task comparisons.

Also, based on the geolocation parameter data of the assets, certain service providers within a service area that do not have assets that satisfy the geolocation parameter data at the acceptance time can be excluded from the market at the acceptance time. This also increases the accuracy of the market comparables at the acceptance time, especially in implementations in which the asset locations are monitored in real time.

In implementations that receive task allocation information and convert the received information into a standardized format for storage, the system facilitates interfacing with pre-existing software system utilized by providers. This simplifies onboarding of providers, and reduces or eliminates software incompatibility issues.

Other advantages include the reduction of human error in asset allocation determinations, as the data that is time stamped indicated the actual assets and asset types available at a specific time.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A, 1B and 1C are illustrations of service provider service areas in which assets are allocation for remediation tasks.

FIG. 2A is a system diagram of an asset reconciliation system deployed in a network environment.

FIG. 2B is a flow diagram of an example process of generating a task comparison for a task allocated at an acceptance time.

FIGS. 3A-3E are illustrations to example task comparison summaries.

FIG. 4 is a flow diagram of an example process of selecting assets subject to geolocation parameters for inclusion in a task comparison.

Like reference numbers and designations in the various drawings indicate like elements.

### DETAILED DESCRIPTION

This written description is described in the context of a tree remediation service, and illustratively describes cranes as assets that are associated with geolocation parameter data. However, any service in which tasks are allocated and in which assets associated with geolocation parameters can benefit from utilizing systems and method that realize the subject matter below.

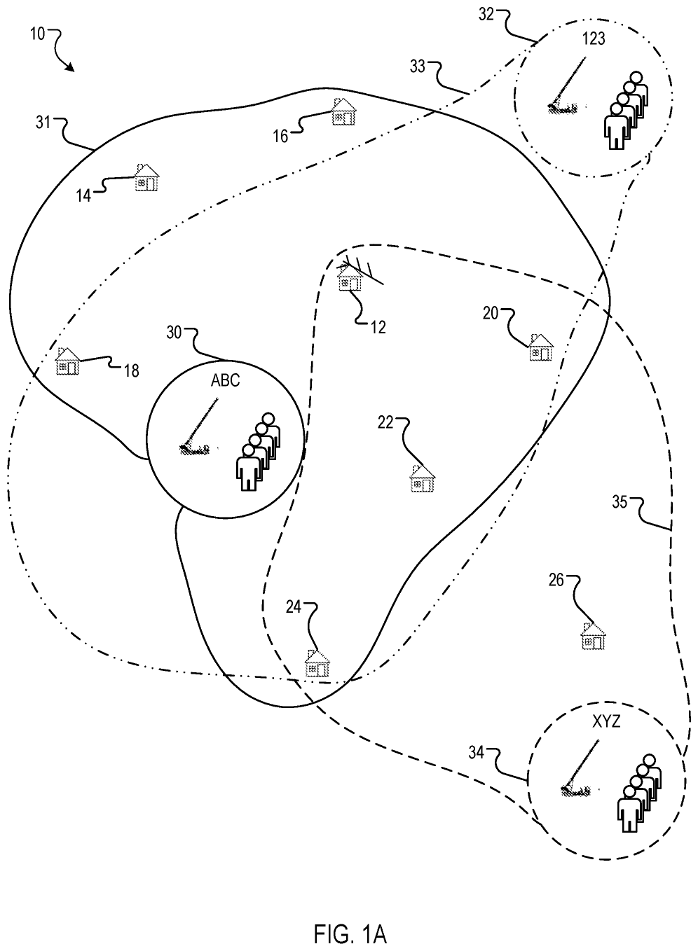

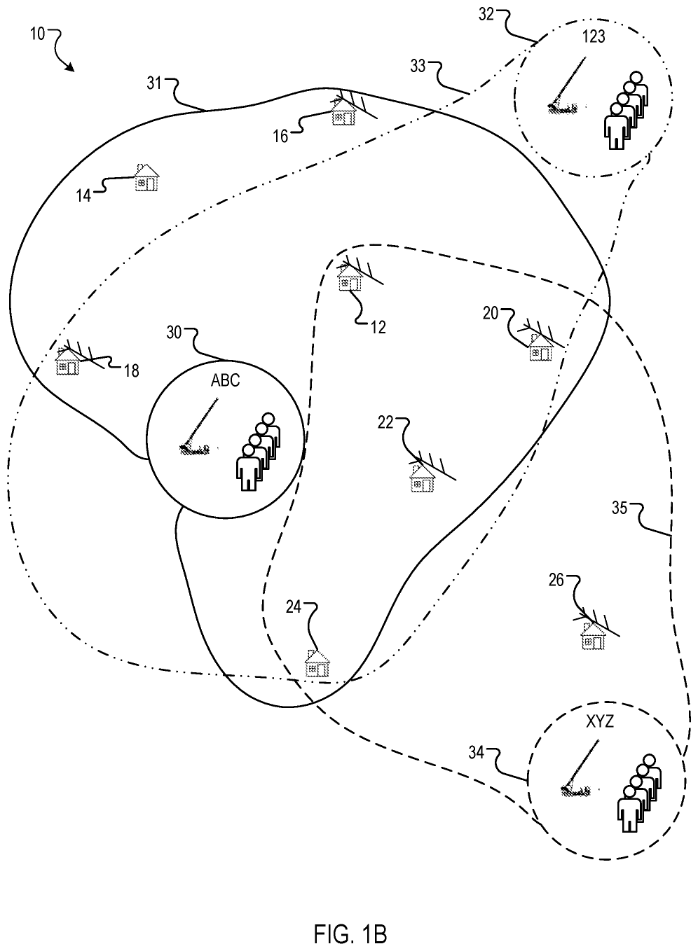

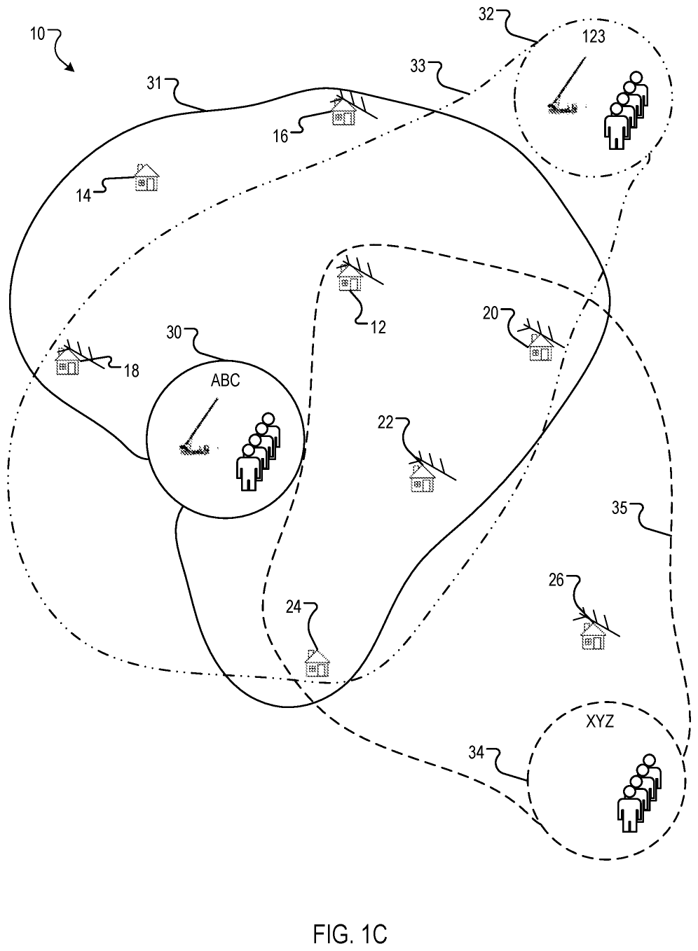

FIGS. 1A and 1B are illustrations of service provider service areas in which assets are allocation for remediation tasks. The depicted environment 10 includes buildings 12, 14, 16, 18, 20, 22, 24 and 26, such as personal residences. Service providers 30, 32 and 34 are tree remediation services that remove trees, such as fallen trees or trees that need to be removed for other reason. Often a crane asset is required to remove a large tree, and each of the providers 30, 32 and 34 is associated with crane asset. The providers 30, 32 and 34 may own the respective crane assets, or may contract with a crane rental service. The providers 30, 32 and 34 also have other assets, such as workers, vehicles, etc.

As illustrated in FIG. 1, each provider 30, 32, and 34 has a respective service area 31, 33, and 35. The service areas may be jurisdiction regions, e.g., cities, geometric regions, e.g., a radius from a central point, or any other defined area. Some buildings are in locations overlapped by all three services areas, i.e., buildings 12, 20, 22 and 24; while some are in locations overlapped by two service areas, i.e., building 18; and some are located in only one service area, i.e., buildings 14 and 16 for service area 31, and building 26 for service area 35. The service areas may also be defined by how far a provider is willing to transit an asset. For example, a large tree crane requires lead time and expense to move, and a provider may limit its service area of the crane. The service area can be limited to a maximum service area that is measured from a home base of the first asset.

In FIG. 1A, building 12 is at a location that requires a tree removal, as indicated by the fallen tree on the building 12. All other buildings do not require service. Thus, FIG. 1 illustrates a “normal” demand level in which, for example, a tree has fallen for reasons other than storm. Because building 12 is covered by all three service areas and demand for services is normal, the market is in a “normal” state and the owner of building 12 will be able to contract with one of the providers 30, 32 and 34 relatively quickly. Also, because service supply is more than demand, the prices will be relatively lower than when demand is much higher.

FIG. 1B illustrates the same environment 10 but after a storm that has blown over a number of trees. Here, buildings 12, 16, 18, 20, 22, and 26 require service. In this situation, demand now outstrips service supply. Moreover, some buildings have only one option for a provider, such as building 16, which is served only by provider 30, and building 26, which is served only by provider 34. As such, the lead time and prices for the task of clearing the tree for these two buildings may be longer and/or higher than the lead time and prices for the same task for buildings 12, 20 and 22.

Over time, the providers and building owners will agree to remediation tasks, e.g., clearing and removing fallen trees. For each task, a set of assets are allocated to perform the task. The assets, for example, include a crane, the crane operations, and workers that cut and clear the timber. While a provider may have many workers, it typically has a fewer number of associated cranes, i.e., cranes it owns or has access to. Additionally, the cranes are usually allocated to a service area. For example, a tree service may be willing to contract to send an arborist up to 100 miles away, but may limit the service area of a large crane to within 50 miles of its home office.

Additionally, service areas may change over time. For example, in FIG. 1C, the provider 34 may have transferred its crane asset to another service area in which there was also a storm, and thus it may not be able to provide a crane for tasks for any of the buildings depicted in FIG. 1C.

Also, some assets may not be available for a service area even if the geolocation parameter data indicates the asset is currently serving the service area. For example, a crane may have a mechanical failure and, because of the failure, removed from service.

At the time of acceptance of a task, the building owner and a provider contract for a service. The prices are determined at the acceptance time. The price and lead time may depend on market conditions. For example, in the environment of FIG. 1A, when demand is low, the providers may not be paying overtime for crews, and crane rates may be lower and with shorter lead time than in the environment of FIG. 1B or 1C, when crane rates are high and crews may be working overtime.

Once a job is completed, the provider is to be paid. Typically, remediation costs are covered by insurers, and the providers contact insurers for payment. Insurers will pay market rates, which are reasonable and customary rates for mitigation work performed on insurance claims. Typically, the provider submits the task bill to the provider several days (or longer), after the acceptance time of the contract, and after the task has been completed. However, determining market rates is difficult, especially during high demand situations.

Not only are comparables difficult to obtain after an acceptance time, but it is difficult if not impossible to determine when certain assets were available for service areas. For example, as described above, the provider 34 may have temporarily transferred its crane asset to another service area in which there was also a storm, and thus it may not be able to provide a crane for tasks for any of the buildings depicted in FIG. 1C at the acceptance time of a contract between provider 30 and the owner of building 22. Thus, several weeks later, when assessing market rates, the provider 34 may again have its crane asset available for the service area 35. An adjustor may thus determine that provider 34 should be used in determining market rates at the acceptance time, when, in fact, provider 34 could not participate in the market that required a crane.

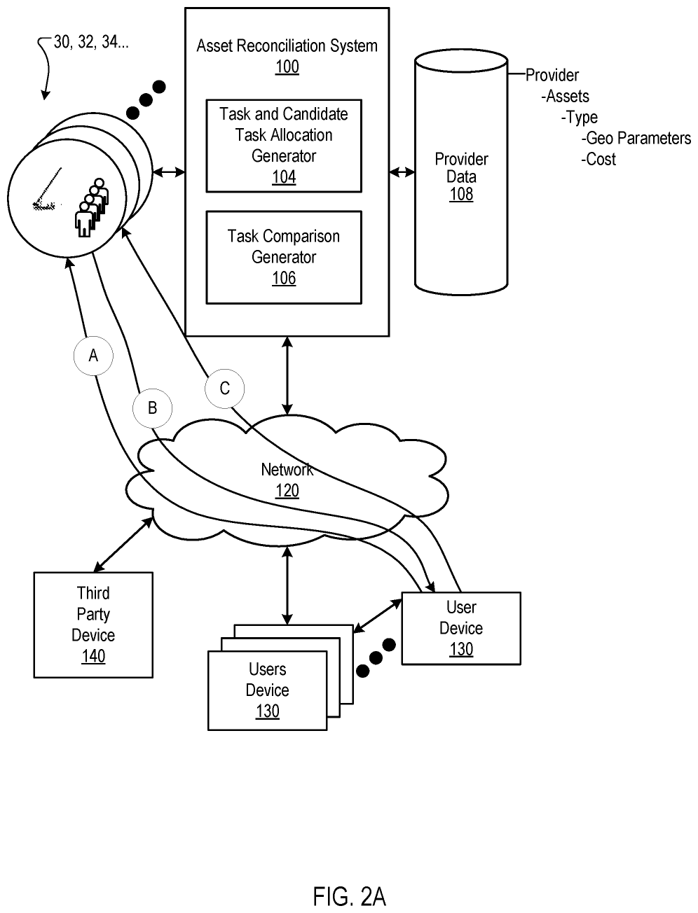

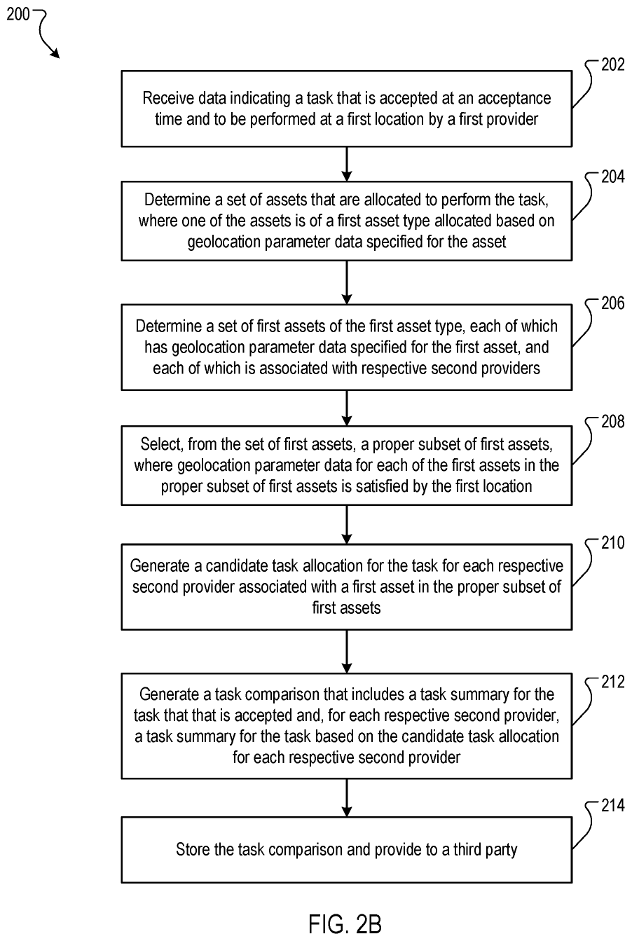

FIG. 2A is a system diagram of an asset reconciliation system 100 deployed in a network environment. The system 100 generates a task comparison for an acceptance time that accurately describes market conditions at acceptance time. Operation of the system 100 is also described with reference to FIG. 2B, which is a flow diagram of an example process of generating a task comparison for a task allocated at an acceptance time. The system is implemented in a data processing apparatus that is separate from the providers 30. The system 100 can also be separate from third party insures.

Providers 30, 32, 34 provide provider data 108 to the task allocations system 100. The provider data includes, for each provider, data describing assets of the provider and the asset types. For example, assets include worker types, which are crew members and their respective rates, and equipment type. Some equipment assets, such as cranes, are associated with geolocation parameter data specified for the asset. The geolocation parameter data describes a service area in which the particular asset may be deployed for a task. Examples of geolocation parameter data can be geo-fence data, which is a set of coordinates that describe the service area; jurisdictional data, such as a list of cities or zip codes that describe the service area; geometric data, such as a defined radius measured from a home base; or other data appropriate to determine an area over which service may be provided.

The geolocation parameter data may also be time dependent, e.g., a particular provide may provide a crane asset for a first service area for a first time period, and may provide the same crane for a second service area separate from the first service area for a second time period. For example, during a normal demand period, a particular provider may place a crane asset at a first office for a first week, and then place the crane asset at a second office for a second week, and schedule jobs that require a crane in the respective service areas for those respective weeks. The periodic repositioning reduces transit costs for the crane asset.

The provider data can also include time data that indicates when certain information is valid, e.g., a particular crane may have multiple sets of geolocation parameter data, as the crane may be moved to service different service areas, based on demand. The time the crane is servicing a particular area is indicated by the time stamps for the geolocation parameter data. Time stamps can be used to indicate the time relevance of other data, such as rates, equipment availability due to equipment being in service or out for maintenance or repair, etc.

The system 100 can also include whether an asset with geolocation parameter data indicating a service area is actually available for the service area. For example, a crane with a mechanical failure may be removed from service, but its geolocation parameter is not changed. Instead, a provider may indicate with the system 100 the availability of the asset, e.g., an “In Service” field with a binary value of Yes or No.

In some implementations, a user, using a user device 130, contacts providers 30, 32 and 34 directly, as indicated by flow path A. Once a provider is selected, e.g., provider 30, the selected provider sends the user a contract/agreement, as indicated by flow path B. The user then executes the contract, as illustrated by flow path C. The provider 30 then performs the contracted task and reports the task to the asset reconciliation system 100. Data describing the contracted task is then stored in the provider data 108.

In some implementations, the provider systems communicate with the system 100 by means of an application programming interface (API) deployed at the provider systems. This allows the system 100 to interface with pre-existing software systems utilized by providers. The task allocation information from the provider is thus converted into a standardized format for storage. This simplifies onboarding of providers, and reduces or eliminates software incompatibility issues.

In another implementation, the contract information is provided by a provider to the system 100, and the system 100 generates a contract for execution by the customer. The contract may be presented in a frame or environment within the provider's web page so that the customer's experience is that of a continuous experience with the with the provider. Once executed, the contract information is sent to the provider's system for scheduling and recordation. This functionality can also be facilitated by means of an API at the provider system, or through a software application provided to the provider by the system 100.

In yet other implementations, the provider may execute a paper contract. The paper contract can then be scanned by the provider and task data extracted from the scanned data, or, alternatively, the provider can simply input the terms of the paper contract into the provider system, which then sends the data to the system 100, or even log onto the system 100 to manually input the contract terms and acceptance time.

In another implementation, the asset reconciliation system can be used as a market portal through which users search for providers and contract with the providers. In yet other implementations, the electronic contracts the providers send to the user devices can be sent directly from the user device to the asset reconciliation system 100 at the acceptance time.

After the task is performed, the provider 30 will follow up with third party insurance carriers for payment. As described above, the determination of fair market rates at the time of the contract is part of the insurance claim process. The system 100 facilitates quick and accurate market comparisons. Generation of such market comparisons is described with reference to FIG. 2B. The process 200 of FIG. 2B can be performed by one or more data processing apparatus programmed to performed the steps described below. While a particular software architecture is illustrated, other software configurations can also be used.

The process 200 receives data indicating a task that is accepted at an acceptance time and to be performed at a first location by a first provider (202). For example, in preparing a comparable for a bill submitted by the provider 30, a third party, such as an insurance company, may submit a request to the system 100 for comparables.

The process 200 determines, for the task, a set of assets that are allocated to perform the task, wherein at least one of the assets is of a first asset type allocated based on geolocation parameter data specified for the asset (204). For example, assume the task performed by the provider 30 required a crane asset and a crew of four to operate the crane, cut a fallen tree, and remove the tree from a property. The task and candidate task allocation generator 104 executes logic to process the task data stored in the provider data 108 to determine the assets and the asset types. The first set of assets also includes other assets of different types, which may not have associated geolocation parameter data, e.g., workers, a skid-steer loader, and grappler equipment, for example.

The asset type for a certain assets, e.g., a crane, may include multiple asset types. For example, crane may be rated by tonnage, e.g., 30 tons, 20 tons, etc., by boom, e.g., 60 foot boom, 80 foot boom, etc. These ratings are indicated by asset type. Thus, in some implementations, the system 100 includes logic that determines whether the asset type for the asset of second provider meets the asset type of the task. For example, if the asset type of the task was a 30 ton crane, and the crane asset for another provider is only a 20 ton crane, then the system determines the 20 ton crane is not of the first asset type, as the 20 ton crane cannot do a job for which the 30 ton crane can. Likewise, if the asset type of the task was a 30 ton crane, and the crane asset for another provider is a 35 ton crane, then the system determines the 35 ton crane is of the first asset type, as the 35 ton crane can do a job for which the 30 ton crane can. In other words, an asset of a first type can be determined to meet another asset of a second type if the asset of the first type is defined as having capabilities the meet or exceed the asset of the second type.

The process 200 determines a set of first assets of the first asset type, each of which has geolocation parameter data specified for the first asset, and each of which is associated with respective second providers (206). For example, the task and candidate task allocation generator 104 accesses the provider data to determine which providers have cranes that were required to perform the contracted task performed by provider 30.

However, just because a provider has an asset in its possession does not mean that the provider could have agreed to perform the task at the acceptance time. For example, a particular provider may have repositioned a crane asset such that it could not have agreed to perform the task in a service area, such as in the case of provider 34 in FIG. 1C. Likewise, a particular provider may have the crane asset in its possession, but does not operate in a particular service area, such as provider 30 for building 26 in FIGS. 1A-1C. Additionally, a particular provider may have the crane asset in its possession and for a service area, but the asset is removed from service for repair or maintenance.

The process 200 thus selects, from the set of first assets, a proper subset of first assets, where geolocation parameter data for each of the first assets in the proper subset of first assets is satisfied by the first location (208). For example, in FIG. 1A, for building 12, all three crane assets would be selected, as the three cranes each respectively have geolocation parameter data describing the respective service areas 31, 33, and 35, each of which are satisfied by the location of building 12. By way of another example, if the location is for building 18, as in FIG. 1B, then only the cranes for providers 30 and 32 are selected, as the geolocation parameter data for the crane of provider 34 is not satisfied by the location of building 18, i.e., building 18 is outside of the service area 35. These selections are determined by the task and candidate task allocation generator 104.

In some implementations, the geolocation parameter data for each first asset includes data indicating the times of the geolocation parameter data. For example, as described above with reference to FIG. 1C, the crane for provider 34 would have two sets of geolocation parameter data—a first set with a time duration indicating the time the asset was within the service area 35, and a second set with a time duration indicating the time the asset was within a second service area outside of service are 35. In these situations, the geolocation parameter data for each first asset is time varying such that the geolocation parameter data differs based on time. Accordingly, the geolocation parameter data for each of the first assets in the proper subset of first assets the geolocation data that is satisfied by the first location and at the acceptance time, i.e., the acceptance time is within the time duration for which the geolocation data that is satisfied by the first location.

The process 200 generates a candidate task allocation for the task for each respective second provider associated with a first asset in the proper subset of first assets (210). Once second providers that had assets that could have performed the task are determined, the task comparison generator 106 generates a candidate task allocation for the second provider. Each candidate task allocation includes the first asset associated with the respective second provider, and one or more other assets, each of which is an asset type that is different from the first asset type and associated with the respective second provider. In other words, for each second provider, a set of assets, e.g., crane and crew, that is similar to the set of assets that the provider 30 contracted to perform the accepted task, is generated. The data are retrieved by the comparison generator 106 from the provider data 108. These are referred to as “candidate task allocations,” as they were candidate task allocations that were available for contract at the acceptance time.

In some implementations, each second provider selected must also have a set of other assets listed in the task. For example, assume the task for which a task comparison summary included the following assets: 1) a 30 ton crane; 2) a crew of five workers; 3) a skid-steer loader; and 4) a grappler. Assume also only the 30 ton crane has associated geolocation parameter date, and that four other providers are identified with a 30 ton (or greater) crane that are also satisfied by the location of the task. Of the four other providers, one does not have a grappler available at the acceptance time, as indicated in the provider data 108. Thus, the system 100 may determine the provider that does not have the grappler available at the acceptance time is not to be considered in the task summary generation.

Particular costs and charges, however, need not match between the task and candidate tasks. For example, the provider of the task may have charged port-to-port charges for crane movement, while another provider does not incur such charges. This other provider would be included for the candidate task as long as it had the necessary assets available to offer at the acceptance time.

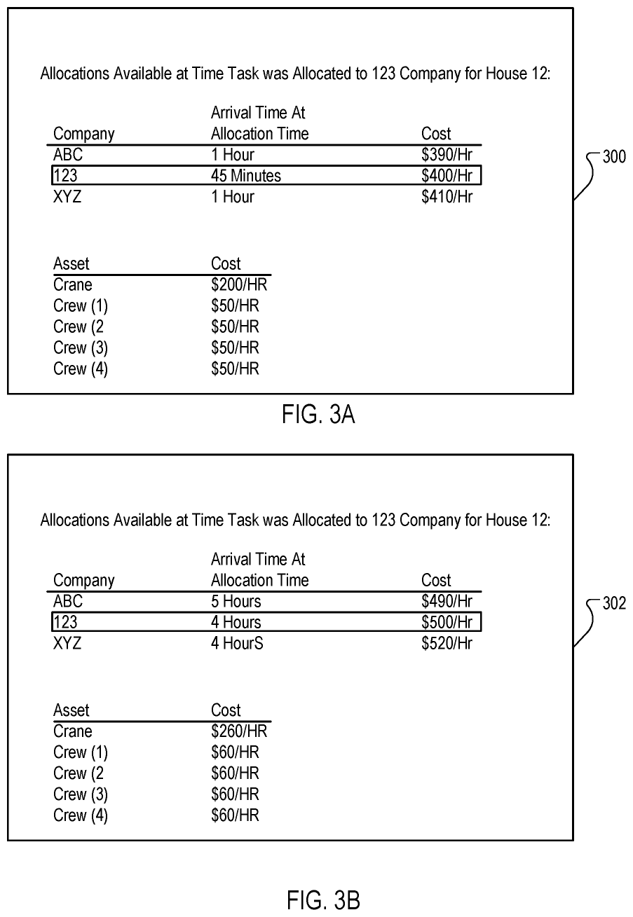

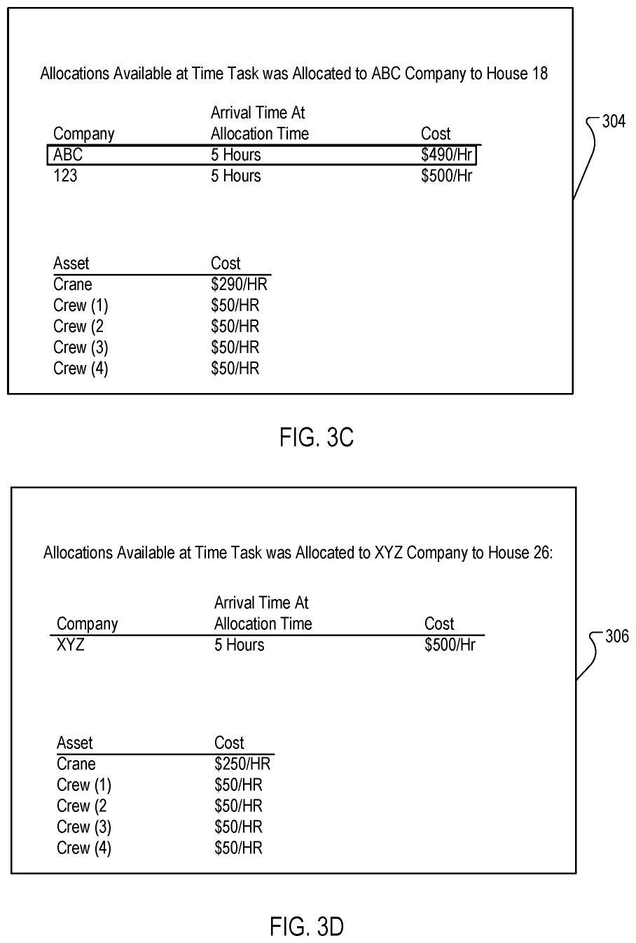

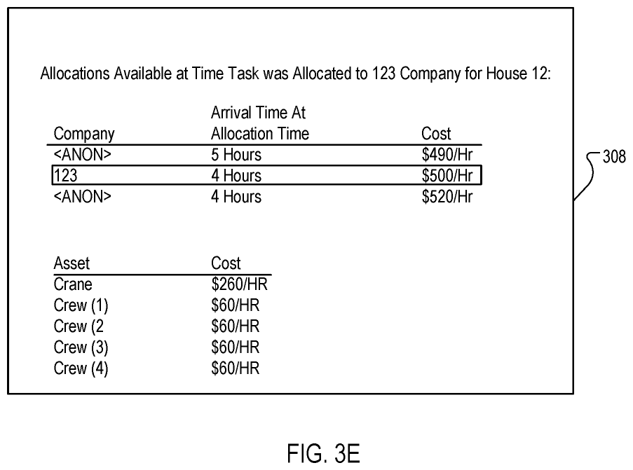

The process 200 generates a task comparison that includes a task summary for the task that that is accepted and, for each respective second provider, a task summary for the task based on the candidate task allocation for each respective second provider (212). The comparison provides summaries of the candidate tasks and the accepted task. Examples are illustrated in FIGS. 3A-3E.

The process 200 stores the task comparison and provide to a third party (214). For example, the comparison is stored in the provider data and provided to the third-party insurer, for example, to an insurer using a third party device 140.

In some implementations, the system 100 receives data specifying the locations of the first assets. Based on accepted allocations of the providers, the system 100 can calculate, given the distance from the particular task for which the comparables are being generated, an arrival time at the first location determined from the acceptance time. The arrival time is then included in the candidate task allocation. In other implementations, the location need not be determined, and the arrival time can be determined based on accepted tasks of the other providers.

The task comparison also includes, in some implementations, a respective task cost for each candidate task allocation, and the cost is included in the task comparisons. The task cost can be determined from rates stored in the provider data 108. Providers can update their rates with the system 100 periodically. Alternatively, the provider computer systems may include an API that reports to the system 100 rate changes and geolocation parameter data changes as they occur in the provider system so the system 100 is always up to date. In some implementations, the rate changes, geolocation parameter data changes, and other changes for determining candidate task allocations are time stamped for when the changes occur. This enables the system 100 to more accurately compare a task allocation at an acceptance time in the past to candidate task allocations at the acceptance time. Thus, the tasks costs are also tagged by time and a cost history for each provider is stored in the provider data 108. Accordingly, each respective task cost for a candidate task allocation is a task cost determined for the acceptance time.

In some implementations, the candidate task summaries for an accepted task are anonymized. This precludes leakage or disclosure of competitor costs to a particular providers should the provider be provided the task comparison. The system 100 generates the task summary for the task based on the candidate task allocation for each respective second provider by generating an anonymized task summary that does not reveal the identity of each second provider. Thus, for each second provider, the system does not include the second provider name or other identifying information in the task summary.

FIGS. 3A-3D are illustrations to example task comparison summaries. In FIG. 3A, the task comparison summary 300 is generated for a task allocated to provider 32 for house 12 in the environment of FIG. 1A. This task comparison is for a market during a “normal” demand. As show, the allocated task is indicated by the selection box, and the candidate tasks are outside the selection box. The corresponding costs determined are displayed, and the set of assets for the selected task is also displayed.

In FIG. 3B, the task comparison summary 302 is generated for a task allocated to provider 32 for house 12 in the environment of FIG. 1B. Here, demand was much higher at the acceptance time, and thus the lead time and costs have increased.

In FIG. 3C, the task comparison summary 304 is generated for a task allocated to provider 30 for house 18 in the environment of FIG. 1B. Here, house 18 is in service areas 31 and 33, and outside of service area 35. Accordingly, the only candidate task to be generated is for the provider 32, as provider 32 has a crane asset with geolocation parameter data satisfied by the location of house 18, while the geolocation parameter data of the crane asset of provider 34 is not satisfied by the location of house 18.

In FIG. 3D, the task comparison summary 306 is generated for a task allocated to provider 34 for house 26 in the environment of FIG. 1B. Here, house 26 is only serviced by the provider 34, and thus no candidate task allocations are generated.

In FIG. 3E, the task comparison summary 308 is generated for a task allocated to provider 32 for house 12 in the environment of FIG. 1A. Here, however, the other providers are not identified, and thus the task comparison summary is anonymized.

In some implementations, the task data includes the actual charges incurred for the task. For example, at acceptance time, the task may be bid at $5,000. However, the customer may actually only be billed $4,500, as the task may have taken less time than estimated. In these implementations, the time incurred for actual performance of the task is used for calculating the estimated cost of each candidate task.

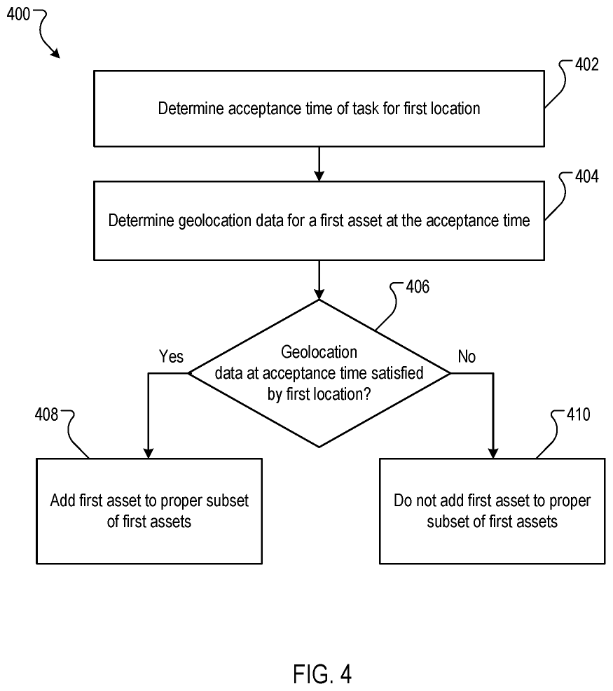

FIG. 4 is a flow diagram of an example process 400 of selecting assets subject to geolocation parameters for inclusion in a task comparison. The process 400 can be implemented by the task and candidate task allocation generator 104.

The process 400 determines an acceptance time of the task for the first location (402). For example, the time at which a customer agrees to a contract with a provider is recorded with the contract, and provided to the system 100. This time is the acceptance time.

The process 400 determines geolocation data for a first asset at the acceptance time (404). For example, for each provider that has a crane asset, the system accesses the geolocation parameter data for the respective cranes to determine a service area for the crane. Because the geolocation parameter data may change over time, the geolocation parameter data for a crane at the acceptance time is used.

The process 400 determines whether geolocation data at the acceptance time is satisfied by first location (406). Once the geolocation parameter data for a crane at the acceptance time is determined, then the location at which the task was performed is compared to the geolocation parameter data. If the location falls within a region defined by the geolocation parameter data, then the geolocation data is satisfied by the first location.

If the geolocation data at the acceptance time is satisfied by first location, then the process adds the first asset the proper subset of first assets (408). The provider that is associated with the first asset is then considered to be part of the market at the acceptance time.

Conversely, if the geolocation data at the acceptance time is not satisfied by first location, then the process does not add the first asset the proper subset of first assets (408). The provider that is associated with the first asset is then considered to not be part of the market at the acceptance time.

In some implementations, the actual location of an asset at the acceptance time can be used to determine whether the asset, and thus the provider, can be included in a task comparison summary. For example, while a service area may be specified for an asset, the asset itself may be at a location that is far outside of the service area, e.g., due to transit, or for some other reason. The geolocation of the asset can be reported to the system 100 either by the providers 30, or by a device that is affixed to the asset and reports a geolocation periodically to the system 100. In these implementations, the system 100 may determine the geolocation parameter data for the first asset is satisfied when the current geolocation of the first asset is within a threshold distance of the service area.

For example, referring to FIG. 1A, the threshold distance may be fifty miles. Thus, if a crane of provider 30 is not within fifty miles of the service area 31 at the acceptance time, the system 100 may determine that provider 30 cannot service the service area, even if the geolocation parameter data is satisfied by a particular location within the service area.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving, at the data processing apparatus, data indicating a task that is accepted at an acceptance time and to be performed at a first location by a first provider;
determining, by the data processing apparatus and for the task, a set of assets that are allocated to perform the task, wherein at least one of the assets is of a first asset type allocated based on geolocation parameter data specified for the asset;
determining, by the data processing apparatus and for the first asset type, a set of first assets of the first asset type, each of which has geolocation parameter data specified for the first asset, and each of which is associated with respective second providers;
selecting, by the data processing apparatus and from the set of first assets, a proper subset of first assets, wherein:
the geolocation parameter data for each of the first assets in the proper subset of first assets is satisfied by the first location; and
the geolocation parameter data for each of the first assets not in the proper subset of first assets is not satisfied by the first location;
for each respective second provider associated with a first asset in the proper subset of first assets, generating, by the data processing apparatus, a candidate task allocation for the task, the candidate task allocation comprising:
the first asset associated with the respective second provider;
one or more other assets, each of the one or more other assets being of an asset type that is different from the first asset type and associated with the respective second provider;
generating, by the data processing apparatus, a task comparison that includes a task summary for the task that that is accepted and, for each respective second provider, a task summary for the task based on the candidate task allocation for each respective second provider;
storing, by the data processing apparatus, the task comparison in a data store; and
providing, by the data processing apparatus, the task comparison to a third party; wherein:
the data processing apparatus is separate from the first provider and each of the second providers.

2. The computer-implemented method of claim 1, wherein:
the geolocation parameter data for each of the first assets specifies a service area; and
selecting, from the set of first assets, the proper subset of first assets, comprises:
for each first asset, determining whether the first location was within the service area specified by the geolocation parameter data for the first asset at the acceptance time; and
determining the geolocation parameter data for the first asset is satisfied by the first location when the first location is within the service area specified by the geolocation parameter data for the first asset at the acceptance time.

3. The computer-implemented method of claim 2, wherein:
the service area specified by the geolocation parameter data is specified by the provider associated with the first asset.

4. The computer-implemented method of claim 3, further comprising:
periodically receiving, by the data processing apparatus, for each first asset, data indicating a current service area for the first asset.

5. The computer-implemented method of claim 4, wherein periodically receiving, by the data processing apparatus, for each first asset, data indicating the current geolocation of the first asset, comprises receiving, from a device affixed to the first asset, the data indicating the current location of the first asset.

6. The computer-implemented method of claim 5, further comprising determining the geolocation parameter data for the first asset is satisfied when the current geolocation of the first asset is within a threshold distance of the service area.

7. The computer-implemented method of claim 3, wherein:
the service area specified by the geolocation parameter data is limited to a maximum service area that is measure from a home base of the first asset; and
each first asset in the proper subset of first assets has geolocation parameter data specifying a maximum service area that includes the first location.

8. The computer-implemented method of claim 1, wherein for each respective second provider associated with a first asset in the proper subset of first assets, generating a candidate task allocation comprises:
determining, for the first asset, a location of the first asset at the acceptance time;
determining, based in part of the location of the first asset, an arrival time at the first location determined from the acceptance time; and
including, in the task allocation, data specifying the arrival time of the first asset.

9. The computer-implemented method of claim 1, wherein for each respective second provider associated with a first asset in the proper subset of first assets, generating a candidate task allocation comprises:
determining, for the first asset and each of the other assets, a respective task cost; and
including, in the candidate task allocation, data specifying the respective task costs.

10. The computer-implemented method of claim 9, wherein each respective task cost is a cost determined for the acceptance time.

11. The computer-implemented method of claim 1, wherein generating the task summary for the task based on the candidate task allocation for each respective second provider comprises generating an anonymized task summary that does not reveal the identity of each second provider.

12. The computer-implemented method of claim 1, wherein:
the geolocation parameter data for each first asset is time varying such that the geolocation parameter data differs based on time; and
the geolocation parameter data for each of the first assets in the proper subset of first assets is satisfied by the first location at the acceptance time.

13. A system, comprising:
a data processing apparatus; and
a non-transitory computer readable medium storing instruction executable by the data processing apparatus and that upon such execution cause the data processing apparatus to perform operations comprising:
receiving, at the data processing apparatus, data indicating a task that is accepted at an acceptance time and to be performed at a first location by a first provider;
determining, by the data processing apparatus and for the task, a set of assets that are allocated to perform the task, wherein at least one of the assets is of a first asset type allocated based on geolocation parameter data specified for the asset;
determining, by the data processing apparatus and for the first asset type, a set of first assets of the first asset type, each of which has geolocation parameter data specified for the first asset, and each of which is associated with respective second providers;
selecting, by the data processing apparatus and from the set of first assets, a proper subset of first assets, wherein:
the geolocation parameter data for each of the first assets in the proper subset of first assets is satisfied by the first location; and
the geolocation parameter data for each of the first assets not in the proper subset of first assets is not satisfied by the first location;
for each respective second provider associated with a first asset in the proper subset of first assets, generating, by the data processing apparatus, a candidate task allocation for the task, the candidate task allocation comprising:
the first asset associated with the respective second provider;
one or more other assets, each of the one or more other assets being of an asset type that is different from the first asset type and associated with the respective second provider;
generating, by the data processing apparatus, a task comparison that includes a task summary for the task that that is accepted and, for each respective second provider, a task summary for the task based on the candidate task allocation for each respective second provider;
storing, by the data processing apparatus, the task comparison in a data store; and
providing, by the data processing apparatus, the task comparison to a third party; wherein:
the data processing apparatus is separate from the first provider and each of the second providers.

14. The system of claim 13, wherein:
the geolocation parameter data for each of the first assets specifies a service area; and
selecting, from the set of first assets, the proper subset of first assets, comprises:
for each first asset, determining whether the first location was within the service area specified by the geolocation parameter data for the first asset at the acceptance time; and
determining the geolocation parameter data for the first asset is satisfied by the first location when the first location is within the service area specified by the geolocation parameter data for the first asset at the acceptance time.

15. The system of claim 14, wherein:
the service area specified by the geolocation parameter data is specified by the provider associated with the first asset.

16. The system of claim 15, further comprising:
periodically receiving, by the data processing apparatus, for each first asset, data indicating a current service area for the first asset.

17. The system of claim 16, wherein periodically receiving, by the data processing apparatus, for each first asset, data indicating the current geolocation of the first asset, comprises receiving, from a device affixed to the first asset, the data indicating the current location of the first asset.

18. The system of claim 17, further comprising determining the geolocation parameter data for the first asset is satisfied when the current geolocation of the first asset is within a threshold distance of the service area.

19. The system of claim 13, wherein:
the geolocation parameter data for each first asset is time varying such that the geolocation parameter data differs based on time; and
the geolocation parameter data for each of the first assets in the proper subset of first assets is satisfied by the first location at the acceptance time

20. A non-transitory computer readable medium storing instruction executable by a data processing apparatus and that upon such execution cause the data processing apparatus to perform operations comprising:
receiving, at the data processing apparatus, data indicating a task that is accepted at an acceptance time and to be performed at a first location by a first provider;
determining, by the data processing apparatus and for the task, a set of assets that are allocated to perform the task, wherein at least one of the assets is of a first asset type allocated based on geolocation parameter data specified for the asset;
determining, by the data processing apparatus and for the first asset type, a set of first assets of the first asset type, each of which has geolocation parameter data specified for the first asset, and each of which is associated with respective second providers;
selecting, by the data processing apparatus and from the set of first assets, a proper subset of first assets, wherein:
the geolocation parameter data for each of the first assets in the proper subset of first assets is satisfied by the first location; and
the geolocation parameter data for each of the first assets not in the proper subset of first assets is not satisfied by the first location;
for each respective second provider associated with a first asset in the proper subset of first assets, generating, by the data processing apparatus, a candidate task allocation for the task, the candidate task allocation comprising:
the first asset associated with the respective second provider;
one or more other assets, each of the one or more other assets being of an asset type that is different from the first asset type and associated with the respective second provider;
generating, by the data processing apparatus, a task comparison that includes a task summary for the task that that is accepted and, for each respective second provider, a task summary for the task based on the candidate task allocation for each respective second provider;
storing, by the data processing apparatus, the task comparison in a data store; and
providing, by the data processing apparatus, the task comparison to a third party; wherein:
the data processing apparatus is separate from the first provider and each of the second providers.
